(19) United States
(12) Patent Application Publication
(10) Pub. No.: US 2026/0012394 A1
(43) Pub. Date: Jan. 8, 2026

(54) SYSTEM AND METHOD FOR AUTOMATED CHANGE IMPACT ANALYSIS

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Manoj SHETTY, Mumbai (IN); Dharmesh A CHITALIYA, Maharashtra (IN); Shubham TIWARI, Madhya Pradesh (IN); Isha SAINI, Madhya Pradesh (IN); Hanumant KADAM, Maharashtra (IN); Sneha VIRKAR, Maharashtra (IN); Neelabh KRISHNA, Haryana (IN)

(73) Assignee: JIO PLATFORMS LIMITED, Ahmedabad (IN)

(21) Appl. No.: 18/993,308

(22) PCT Filed: Jun. 1, 2024
(86) PCT No.: PCT/IN2024/050665

§ 371 Date: Jan. 10, 2025

(30) Foreign Application Priority Data
Jun. 29, 2023 (IN) 202321043762

(51) Int. Cl. H04L 41/14; H04L 41/16; H04L 41/22; H04W 24/02

(52) U.S. Cl. CPC H04L 41/14; H04L 41/16; H04L 41/22; H04W 24/02

(57) ABSTRACT

The present disclosure provides a system (108) and a method for implementing automated change impact analysis in a network, comprising displaying (302), by an interface (206), a selection menu for enabling a selection of a plurality of parameters by a user (102), presenting (304), based on the selection, a list of key performance indicators (KPIs) corresponding to the plurality of parameters within the interface (206), receiving (306) a user input to select one or more KPIs from said list of KPIs and a time period for processing, determining (308), by a processing engine (208), a true average impact data corresponding to each of the one or more selected KPIs, and displaying (310), by the interface (206), a visual representation of the true average impact data representing a change for each of the one or more selected KPIs for said time period.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The present disclosure generally relates to network analysis. More particularly, the present disclosure relates to a system and a method for an automated change impact analysis.

### Definition

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

The expression ‘Key Performance Indicator (KPI)’ used hereinafter in the specification refers to a measurable value that provides insight into the effectiveness of an organization in achieving its fundamental business objectives. KPIs serve as quantifiable metrics, offering a means to assess, analyse, and compare performance over time. The specific KPIs employed can vary widely based on industry and organizational goals. Examples of KPIs encompass metrics such as revenue growth, customer satisfaction scores, conversion rates, and other performance indicators. The significance of KPIs lies in their ability to offer a clear and objective view of an organization's success and progress. These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

Optimizing network performance is crucial for telecommunication service providers. Implementing network changes, such as upgrades or configuration adjustments, can significantly impact various aspects of service delivery.

Change impact analysis plays a crucial role in various industries, including telecommunications, to assess the effects of modifications on key performance indicators (KPIs) and make informed decisions. However, the current methods for conducting such analyses suffer from several inadequacies, leading to inefficiencies and potential errors.

One of the primary challenges faced in change impact analysis is the reliance on manual effort. Engineers are often tasked with scheduling and downloading reports and manually crunching data in spreadsheet software. This process is time-consuming and labour-intensive, particularly when evaluating changes across large geographical areas, such as network regions or circle level modifications. The need for engineers to dedicate significant time and effort to these manual tasks hampers productivity and diverts resources from other critical activities.

Moreover, the manual nature of data crunching introduces a higher risk of errors. Human errors can occur during data extraction, transformation, and computation stages, leading to inaccurate results. These errors can have serious consequences, as decisions based on flawed analysis may result in suboptimal or misguided actions.

Another limitation of current analysis methods is the reliance on average percentage change as the primary measure for quantifying impact. While average percentage change provides a basic understanding of the overall effect, it fails to account for the consistency of change at the cell level. Anomalies or outliers in the data may significantly influence the average, masking the true impact of changes and potentially leading to misinterpretation of results.

Furthermore, the decision-makers may face challenges in effectively communicating the analysis results to stakeholders or deriving meaningful insights from the data.

There is, therefore, a need in the art to provide a system and a method to mitigate the problems associated with the prior arts.

### OBJECTS OF THE INVENTION

Some of the objects of the present disclosure, which at least one embodiment herein satisfies are listed below.

It is an object of the present disclosure to provide a system and a method for automated change impact analysis where user-defined inputs are captured to provide a user-friendly interface for users to select their desired parameters for change impact analysis.

It is an object of the present disclosure to provide a system and a method for automated change impact analysis where anomalies are identified and ignored in the data to accurately assess the impact of each KPI.

It is an object of the present disclosure to provide a system and a method for automated change impact analysis where visualizations and summary reports are generated based on the computed data to enhance data interpretation and facilitate effective communication of analysis findings.

It is an object of the present disclosure to provide a system and a method for automated change impact analysis where users can select geography from a drop-down menu or upload a custom cell list for change impact analysis.

It is an object of the present disclosure to provide a system and a method for automated change impact analysis where users can choose specific dates or days for analysis, considering the analysis frequency.

### SUMMARY

The present disclosure discloses a system for implementing automated change impact analysis in a network, the system comprising an interface configured to allow a user to select a plurality of parameters and key performance indicators (KPIs) from a selection menu for examination and specify a time period and frequency of analysis, a data parameter engine configured to store and manage the plurality of parameters and the KPIs, a processing engine coupled to the data parameter engine, the processing engine is configured to determine a true average impact data for each selected KPI, a database coupled to the processing engine for storing true average impact data representing the change impact for each selected KPI for said time period.

In an embodiment, a Machine Learning (ML) module identifies and removes anomalies in the determined true average impact data.

In an embodiment, the visual representation of the true average impact data is displayed on the interface.

In an embodiment, the selection menu includes at least a geographic region, a list of customized cells, one or more vendors, and/or one or more technologies.

In an embodiment, the user selects the geographical region based on predefined regions or custom-defined areas.

In an embodiment, the user selects at least one vendor and at least one technology from a predefined list or enters custom specifications for analysis.

In an embodiment, the user selects KPIs for analysis based on downlink, uplink, latency, and/or total traffic.

In an embodiment, the selection menu includes a drop-down menu.

In an embodiment, the processing engine filters the list of KPIs based on a pre-defined criteria.

In an embodiment, the system includes a visual representation of change impact data is one or more of the following, a time-series chart depicting the impact for each KPI over said time period, a heatmap visually representing the change impact across selected geographic region(s) or customized cell(s) and a table summarizing the calculated change impact data for each KPI.

In an embodiment, the system generates a detailed report summarizing the analysis, including the plurality of parameters, calculated impact values for each KPI, visual representation of the change impact data and a table summarizing the calculated impact values for each KPI.

The present disclosure discloses a method for implementing automated change impact analysis in a network. The method comprises of displaying, by an interface, a selection menu for enabling a selection of a plurality of parameters by a user, presenting, based on the selection, a list of key performance indicators (KPIs) corresponding to the plurality of parameters within the UI, receiving a user input to select one or more KPIs from said list of KPIs and a time period for processing, determining, by a processing engine, a true average impact data corresponding to each of the one or more selected KPIs, displaying, by the interface, a visual representation of the true average impact data representing a change for each of the one or more selected KPIs for said time period.

In an embodiment, a Machine Learning (ML) module identifies and removes anomalies in the determined true average impact data.

In an embodiment, the selection menu includes at least a geographic region, a list of customized cells, one or more vendors, and/or one or more technologies.

In an embodiment, the user selects the geographical region based on predefined regions or custom-defined areas.

In an embodiment, the user selects at least one vendor and at least one technology from a predefined list or enters custom specifications for analysis.

In an embodiment, the user selects KPIs for analysis based on downlink, uplink, latency, and/or total traffic.

In an embodiment, the time period for analysis is selected by the user from a set of predefined options such as per day, Billing Busy Hour (BBH), and Network Busy Hour (NBH).

In an embodiment, the method further includes filtering or sorting the list of KPIs based on pre-defined criteria.

In an embodiment, the method includes a visual representation of change impact data is one or more of the following, a time-series chart depicting the impact for each KPI over said time period, a heatmap visually representing the change impact across selected geographic region(s) or customized cell(s) and a table summarizing the calculated change impact data for each KPI.

In an embodiment, the method includes generating a detailed report summarizing the analysis, including the plurality of parameters, calculated impact values for each KPI, visual representation of the change impact data and a table summarizing the calculated impact values for each KPI.

In an exemplary embodiment, the present invention discloses a User Equipment (UE) communicatively coupled with a network configured for implementing automated change impact analysis, comprising of displaying, by an interface, a selection menu for enabling a selection of a plurality of parameters by a user, presenting, based on the selection, a list of key performance indicators (KPIs) corresponding to the plurality of parameters within the interface, receiving a user input to select one or more KPIs from said list of KPIs and a time period for processing, determining, by a processing engine, a true average impact data corresponding to each of the one or more selected KPIs, displaying, by the interface, a visual representation of the true average impact data representing a change for each of the one or more selected KPIs for said time period.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture for implementing a system, in accordance with an embodiment of the present disclosure.

FIG. 2 illustrates a schematic block diagram of the disclosed system, in accordance with an embodiment of the present disclosure.

FIG. 3 illustrates a schematic flow diagram of a method for implementation of automated change impact analysis, in accordance with an embodiment of the present disclosure.

FIG. 4-6 illustrates an exemplary representation of a method for automated change impact analysis, in accordance with an embodiment of the present disclosure.

FIG. 7 illustrates an exemplary computer system in which or with which the system and the method are implemented, in accordance with an embodiment of the present disclosure.

FIGS. 8A-8E illustrates a User Interface (UI) setting page that implements the method and the system, in accordance with an embodiment of the present disclosure.

The foregoing shall be more apparent from the following more detailed description of the disclosure.

### LIST OF REFERENCE NUMERALS

100—Network Architecture
102-1, 102-2 . . . 102-N—Users
104-1, 104-2 . . . 104-N—User Equipments
106—Network Element(s)
108—System
202—One or more processor(s)
204—Memory
206—A Plurality of Interfaces
208—Processing Engine
210—Database
212—Data Parameter Engine
300—Method
302—Displaying, by an interface, a selection menu for enabling a selection of a plurality of parameters by a user
304—Presenting, based on the selection, a list of key performance indicators (KPIs) corresponding to the plurality of parameters within the interface
306—Receiving an input by the user to select one or more KPIs from said list of KPIs and a time period for processing
308—Determining, by a processing engine, a true average impact data corresponding to each of the one or more selected KPIs
310—Displaying, by the interface, a visual representation of the true average impact data representing a change for each of the one or more selected KPIs for said time period
700—Computer system
710—External Storage Device
720—Bus
730—Main Memory
740—Read-Only Memory
750—Mass Storage Device
760—Communication Port(s)
770—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

The present disclosure discloses a system and method for providing automated change impact analysis. The system and the method provide an interactive interface that facilitates easy interpretation of the analytical data processed by the logical computation engine and generates visualizations and summary reports based on the computed data.

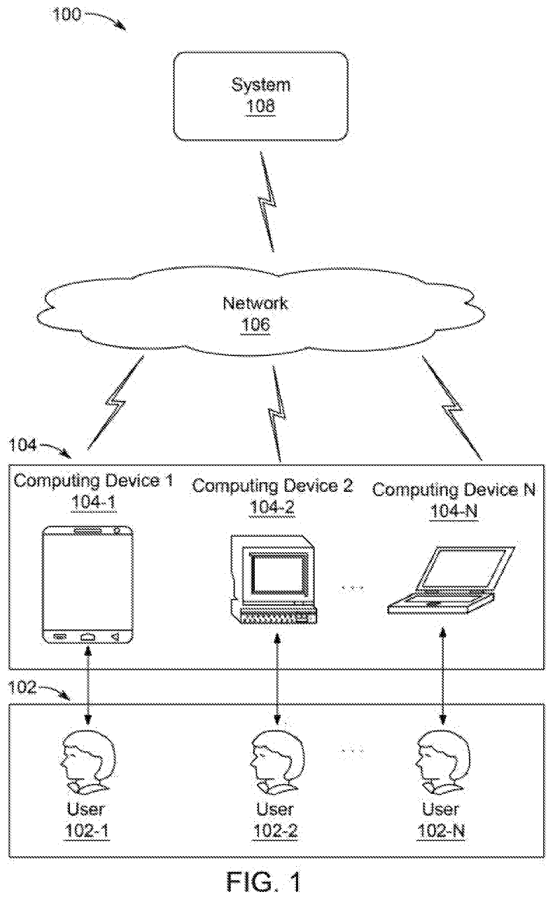

The various embodiments throughout the disclosure will be explained in more detail with reference to FIG. 1-FIG. 5.

FIG. 1 illustrates an example of a network architecture (100) for implementing a system (108) for implementing automated change impact analysis in a network in accordance with an embodiment of the present disclosure.

As illustrated in FIG. 1, one or more computing devices (104-1, 104-2 . . . 104-N) may be connected to the disclosed system (108) through a network element(s) (106). A person of ordinary skill in the art will understand that the one or more User Equipment(s) (UEs) (104-1, 104-2 . . . 104-N) may be collectively referred to as computing devices (104) and individually referred to as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred to as users (102) and individually referred to as the user (102). Further, the computing devices (104) may also be referred as the UE (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102), such as a touchpad, touch-enabled screen, electronic pen, and the like, may be used.

In an embodiment, the network element(s) (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network element (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, one or more processor(s) (202) is configured to execute a plurality of protocols stored in a memory (204). The plurality of protocols includes receiving inputs, implementing logical computation, generating interactive visualizations, and producing summary reports. Further, a memory (204) may be configured to store instructions, said instructions being executable by one or more processors (202) to facilitate the execution of the plurality of protocols.

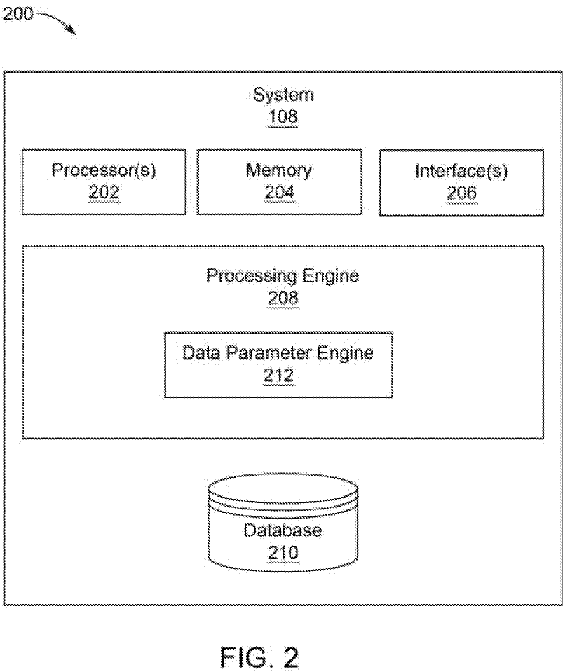

FIG. 2 illustrates an example block diagram (200) of the system (108), in accordance with an embodiment of the present disclosure.

Referring to FIG. 2, in an embodiment, the system (108) may include one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, one or more processor(s) (202) may be configured to fetch and execute computer-readable instructions stored in the memory (204) of the system (108). The memory (204) may be configured to store one or more computer-readable instructions or routines in a non-transitory computer-readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206) or an interface (206). The interface(s) (206) may comprise a variety of interfaces, for example, interfaces for data input and output devices (I/O), storage devices, and the like. The interface(s) (206) may facilitate communication through the system (108). The interface(s) (206) may also provide a communication pathway for one or more components of the system (108). Examples of such components include, but are not limited to, processing engine(s) (208) and a database (210). Further, the processing engine(s) (208) may include a data parameter engine (212) and other engine(s). In an embodiment, the other engine(s) may include, but not limited to, a data ingestion engine, an input/output engine, and a notification engine. The data parameter engine (212) is a component of the system (108) to manage and process various data-related parameters. The primary function of the processing engine(s) (208) is to handle a plurality of parameters received from computing devices (104) associated with the users (102). The plurality of parameters may include information such as geography, vendors, technologies. Other information may also include key performance indicators (KPIs).

In an aspect, the interface (206) may serve as the primary point of interaction between users (102) and the system (108), offering a seamless and intuitive experience. Within this interface, users (102) may encounter several key features tailored to facilitate efficient analysis:

Selection Menu: This menu is designed to streamline the process of defining the analysis parameters. The user (102) may select various options relevant to their specific network change:
Geography: The user (102) can choose a geographic region from a predefined list (e.g., countries, states, cities). The system (108) might also offer the flexibility to define custom areas on a map for a more targeted analysis.
Cell List: This option allows the user (102) to upload a custom list of cells (network elements) for a more granular analysis beyond predefined geographic regions.
Vendors: A menu enables the user (102) to select one or more network equipment vendors whose performance they want to analyse after a change.
Technologies: A menu allows the user (102) to choose specific network technologies impacted by the change (e.g., 4G, 5G, core network technologies, etc.).

In an aspect, the interface (206) may present a list of Key Performance Indicators (KPIs) relevant to network performance and user experience. The KPIs may include:
Network Performance KPIs: Call Success Rate, Call Setup Time, Data Throughput, Packet Loss Rate, Signal Strength, Handoff Success Rate.
User Experience KPIs: End-to-End Service Delay, Buffering Time, Network Availability, Application Performance.
Resource Utilization KPIs: Cell Congestion, Channel Utilization, Backhaul Capacity Utilization.

In an embodiment, the interface (206) may offer filtering or sorting functionalities to allow users (102) to focus on specific categories of KPIs (e.g., downlink, uplink, latency) based on their analysis needs.

In an embodiment, the user (102) may specify a time period for the analysis. Predefined options might be available (e.g., per day, Billing Busy Hour (BBH), and Network Busy Hour (NBH), or the system (108) might allow the user (102) to define custom date ranges. The BBH may potentially refer to the hour within a day (or billing cycle) that generates the highest amount of billing activity for network usage. Analysing performance during BBH can highlight potential bottlenecks or areas for improvement that impact revenue generation. The NBH may refer to the hour within a day (or any defined period) when the network experiences its highest overall traffic volume. Analyzing performance during NBH helps identify how the network handles peak loads and potential congestion issues.

In an embodiment, the interface (206) may allow the user (102) to choose the frequency at which they want the impact assessed. This could be daily, hourly, or based on other relevant timeframes depending on the network change and desired level of granularity.

In an embodiment, the interface (206) may provide clear instructions and help guides to assist the user (102) in selecting appropriate parameters and interpreting the results.

Visualization previews could be displayed within the interface (206) and may give the user (102) an idea of the type of visual representations (charts, heatmaps, tables) they can expect for the change impact data.

In an embodiment, the interface (206) may offer options to save or export the determined data and results for future reference or comparison in a database (210).

In an embodiment, the processing engine(s) (208) may be implemented as a combination of hardware and programming (for example, programmable instructions) to implement one or more functionalities of the processing engine(s) (208). In the examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processing engine(s) (208) may allow the user (102) to select geography from a drop-down menu or upload a custom cell list.

In an embodiment, the processing engine(s) (208) may enable the user (102) to choose vendors and technologies from drop-down menus and select desired KPIs for analysis.

In an embodiment, the processor (202) may allow the user (102) to choose specific dates or days for analysis, in combination with the analysis frequency, and provide an option to compare data for similar days of the week.

In an embodiment, the processor (202) may generate visualizations and summary reports based on the computed data.

In an embodiment, the processing engine(s) (208) may receive one or more inputs from the one or more computing devices (104) associated with the one or more users (102). The one or more inputs may include geography and vendors, as well as technologies and key performance indicators (KPIs). The processing engine(s) (208) may include a Machine Learning (ML) module that auto-identifies and sets an upper threshold and a lower threshold based on the training data that is pre-stored in the memory (204). The data is further trained on past data. Any data from the input that is anomalous will breach the upper threshold and the lower threshold of an algorithm of the ML module. Moreover, the ML module is continuously trained on newly generated data as well. Further, the hyperparameters are also auto-tuned by the ML model on a continuing basis.

In an embodiment, the system (108) may provide the users (102) with diverse visual representations of the change impact data, enhancing their ability to interpret and understand the analysis results effectively. Through time-series charts, the user (102) can visualize the impact of changes on each Key Performance Indicator (KPI) over the selected time period, enabling them to identify trends and patterns in network performance. Additionally, heatmaps offer a graphical depiction of the change impact across various geographic regions or customized cells, providing the user (102) with valuable insights into spatial variations in network performance. Furthermore, tables summarize the calculated change impact data for each KPI, offering the user (102) a concise overview of the analysis results and facilitating comparison and interpretation. These visual representations collectively enhance the usability and comprehensibility of the analysis output, empowering the user (102) to make informed decisions and take appropriate actions based on the insights gained from the system (108).

In an embodiment, the system (108) may generate a comprehensive report that encapsulates the entirety of the analysis conducted. This report includes a detailed overview of the parameters selected for the analysis, providing the user (102) with transparency regarding the variables considered in the assessment. Furthermore, the report presents the calculated impact values for each Key Performance Indicator (KPI), offering the user (102) a clear understanding of the magnitude of change observed in network performance metrics. Additionally, the report incorporates visual representations of the change impact data, such as time-series charts, heatmaps, and tables, facilitating the communication of analysis results in a visually engaging and informative manner. By providing the user (102) with a consolidated summary of the analysis findings, the system (108) empowers decision-makers to gain actionable insights and make informed choices regarding network management and optimization strategies.

In an embodiment, the database (210) may serve as the central repository for the processed results generated by the processing engine(s) (208) within the system (108). The database (210) may act as a historical record of network change impacts, allowing the user (102) to access past analysis results for trend analysis and comparison purposes.

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (108).

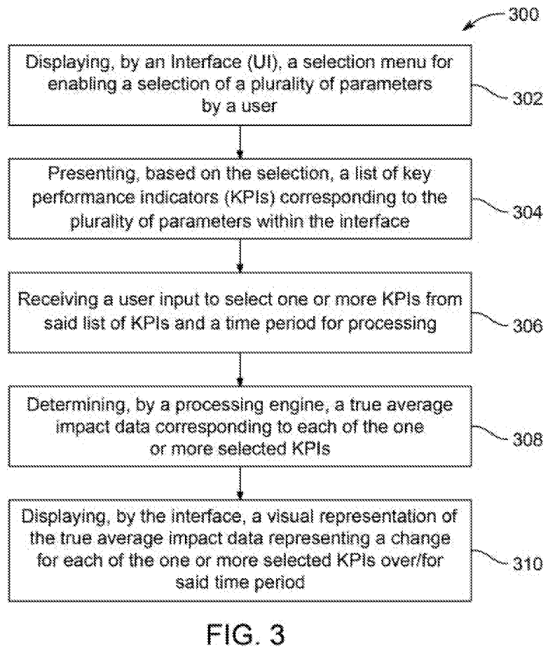

FIG. 3 illustrates an example flow diagram (300) for a method of implementing automated change impact analysis, in accordance with an embodiment of the present disclosure.

As illustrated in FIG. 3, the following steps may be implemented by the system (108) for automated change impact analysis.

At step 302: the method may be configured to display a selection menu through an interface (206), facilitating the user (102) interaction. The selection menu provides the user (102) with the ability to choose from a variety of parameters relevant to the analysis, such as geographic regions, customized cells, vendors, and technologies. The selection menu serves as a user-friendly interface element, enabling intuitive selection of parameters tailored to the user (102) requirements, whether based on predefined options or custom-defined areas.

At step 304: the method (300) may be configured to utilize the processing engine (208) to analyze the selection (304). Based on the chosen parameters, the system (108) presents (304) a list of relevant Key Performance Indicators (KPIs) within the UI. The presented KPIs will correspond to the network elements and functionalities impacted by the chosen parameters (e.g., KPIs related to call success rate for a vendor selection).

At step 306: the user (102) interacts with the interface (206) to select one or more KPIs from the presented list that they want to analyze for change impact. Additionally, the user (102) may specify a time period for which they want to assess the impact (306). This time period may be chosen from predefined options like per day, Billing Busy Hour (BBH), and Network Busy Hour (NBH).

At step 308: the processing engine (208) may determine a true average impact data corresponding to each of the selected KPIs. This involves sophisticated data analysis techniques to calculate the impact of network changes accurately. Additionally, the ML module in the processing engine (208) identifies and removes anomalies in the determined true average impact data, ensuring the reliability and accuracy of the analysis results.

At step 310: Once the impact data is determined, the method proceeds to display a visual representation of the true average impact data within the interface (206). This representation showcases the change for each of the selected KPIs over the specified time period, providing the user (102) with valuable insights into network performance trends and areas of improvement. The visual representation may take various forms, including time-series charts, heatmaps, or tables.

Furthermore, the method may include the generation of a detailed report summarizing the analysis. This report encompasses the plurality of parameters, calculated impact values for each KPI, and visual representations of the change impact data. By offering the user (102) comprehensive insights into network performance dynamics, the method empowers informed decision-making and strategic planning for network optimization and management.

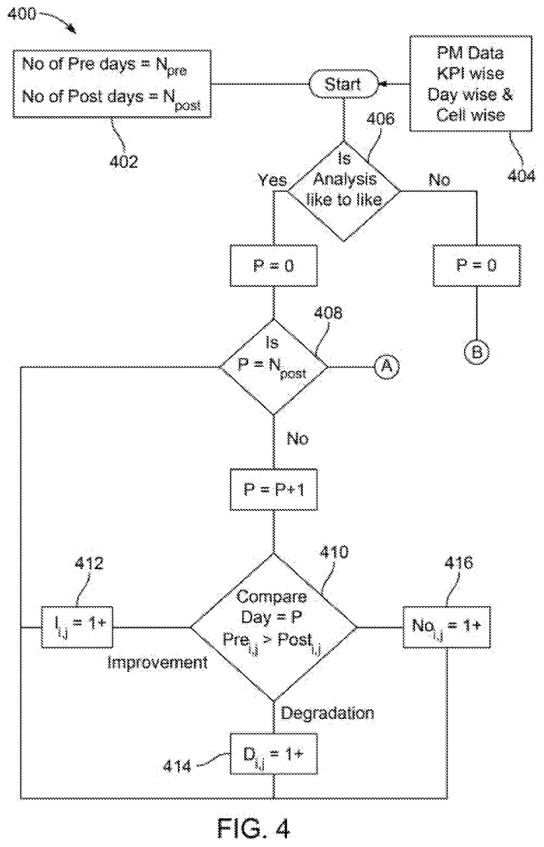

FIGS. 4-6 illustrate the steps the system (108) takes to determine the impact of a network change on various performance metrics (KPIs) based on selections and a pre-defined criteria.

FIG. 4 illustrates like-to-like comparisons in accordance with an embodiment of the present disclosure. Here the like-to-like comparisons may include Monday pre vs Monday post.

In an aspect, at 402, data related to the number of days is collected whenever the user (102) updates or analyses a particular list of days for comparison. This includes the number of previously selected and posted days chosen for analysis.

In an aspect, at 404, the data comprises PM data and the set of Key Performance Indicators (KPIs) the user (102) wants to analyse. These KPIs represent the metrics the user (102) is interested in comparing.

In an aspect, at 406, the user (102) has the option to choose a set of days for analysis. This could involve comparing specific weekdays (like-to-like comparison) such as Monday with Monday or Tuesday with Tuesday.

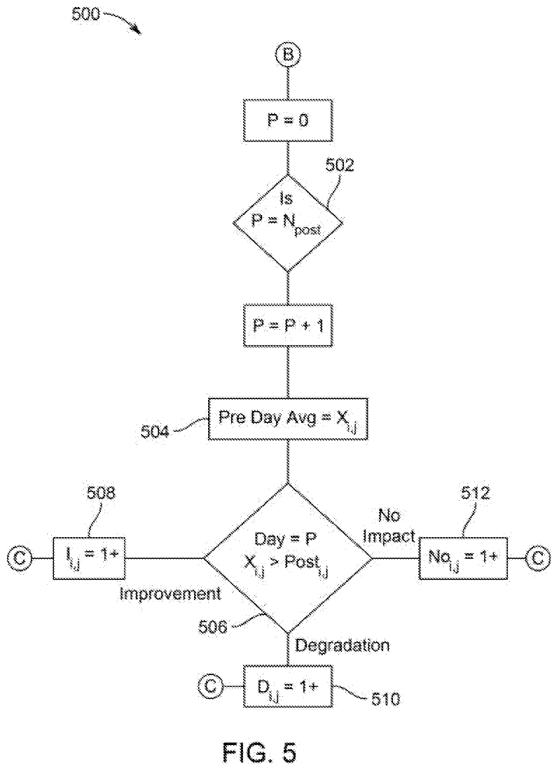

Alternatively, the user (102) can choose to analyse all weekdays (Pre vs Post) irrespective of day-to-day variations. If the user (102) selects like-to-like days, proceed to the leftmost flowchart (FIG. 4). If not, refer to FIG. 5 for further steps.

In an aspect, at 408, based on the user (102) selection of days (e.g., Monday, Tuesday, Wednesday for post), the system (108) performs a day-to-day comparison. It compares the chosen KPIs for Monday pre-change with Monday post-change, Tuesday pre-change with Tuesday post-change, and so on.

In an aspect, at 410, based on the user (102) inputs, the system (108) compares whether there has been an improvement, degradation, or no impact on the selected KPIs. The system (108) refers to a metrics table stored in the backend or database to make this determination. This table contains predefined combinations of seven-day periods. If the number of previous and post-days is within acceptable limits, the system (108) checks how many days the user (102) typically selects for analysis. If, out of seven days, five days show improvement in the post compared to the pre, the report is considered improved (412). If the user (102) selects five or three days, then at least two days should show improvement or one day should show degradation (414). If this condition is not met (416), refer to FIG. 5.

FIG. 5 illustrates a flow chart outlining the process for analysing non-like day selections. Here, the non-like day selections may include Monday, Tuesday, and Wednesday.

In an aspect, at 502, the user (102) selects non-like day comparisons.

In an aspect, at 504, the system (108) aggregates all previous date values and compares them with the post-date values. For example, if they select Monday, Tuesday, and Wednesday for three days, the system (108) averages them as one number and compares that number with the post numbers.

In an aspect, at 506, the post-date values must be higher than the pre-date values.

In an aspect, at 508, if five days out of seven have higher values than the pre, then the condition is considered improved.

In an aspect, at 510, if fewer than five days have higher values, then the condition is considered degraded.

In an aspect, at 512, if exactly five days have higher values, there is considered to be no significant impact and no improvement.

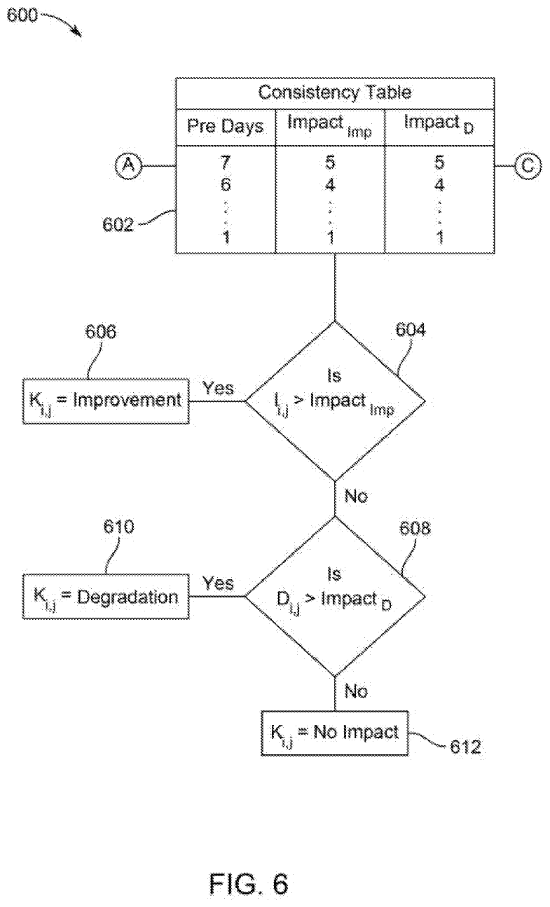

FIG. 6 illustrates a flow chart outlining applying the impact thresholds.

In an aspect, at 602, a table stores pre-defined values for the number of days analyzed (e.g., 7 days) and thresholds for considering improvement or degradation (impact improvement and impact D values).

In an aspect, at 604, if the improved condition from step 506 exceeds the impact improvement value mentioned in the table, then the condition is considered improved.

In an aspect, at 606, if the degraded value from step 508 exceeds the impact D mentioned in the table, then the condition is considered degraded.

In an aspect, at 608, if the degraded value from step 508 is not more than the impact D mentioned in the table, then there is considered to be no impact and no improvement.

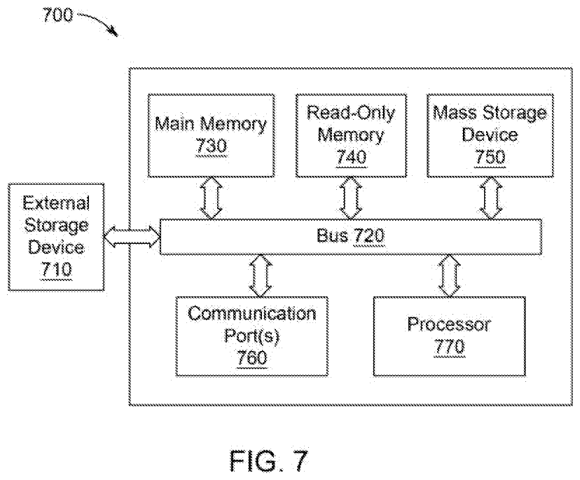

FIG. 7 illustrates an example computer system (700) in which or with which the embodiments of the present disclosure may be implemented.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system (700) connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) may communicatively couple the processor(s) (770) with the other memory, storage, and communication blocks. The bus (720) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (770) to the computer system (700).

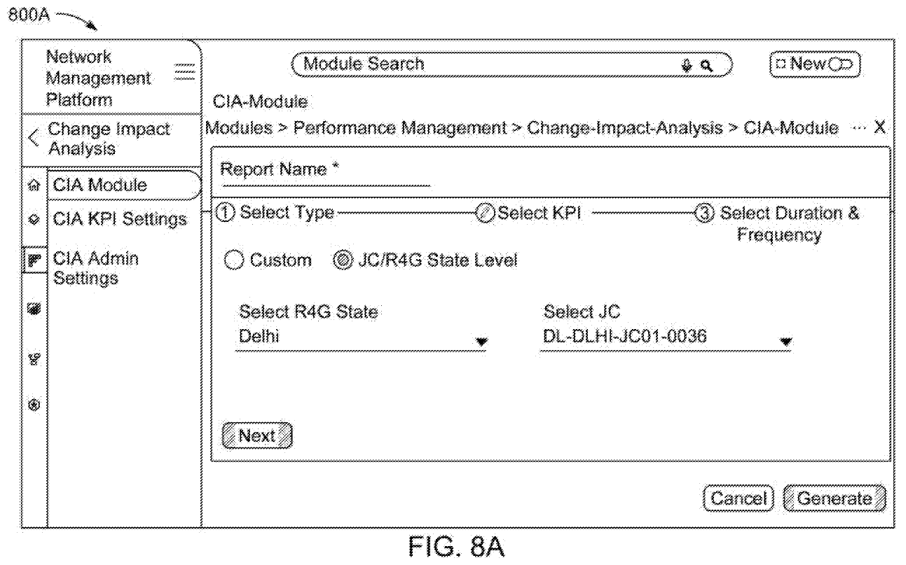

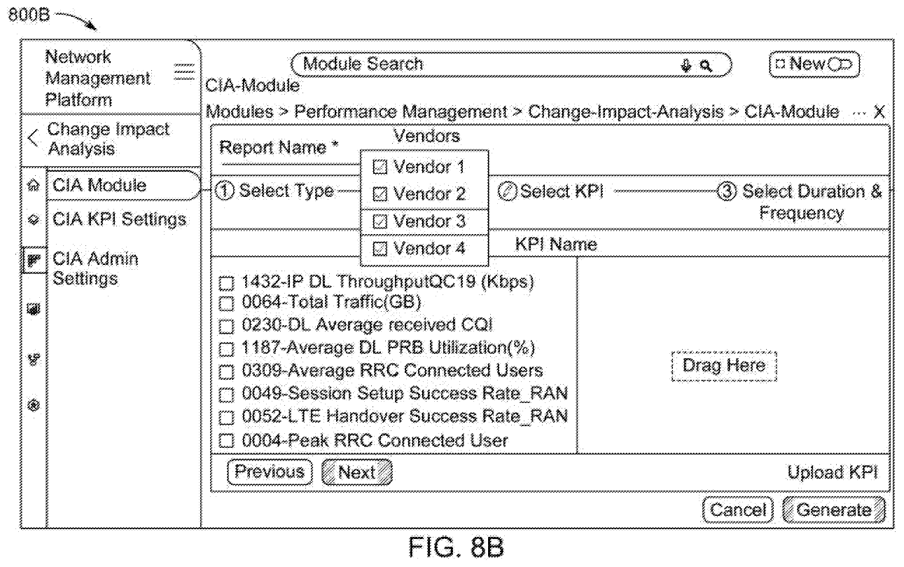

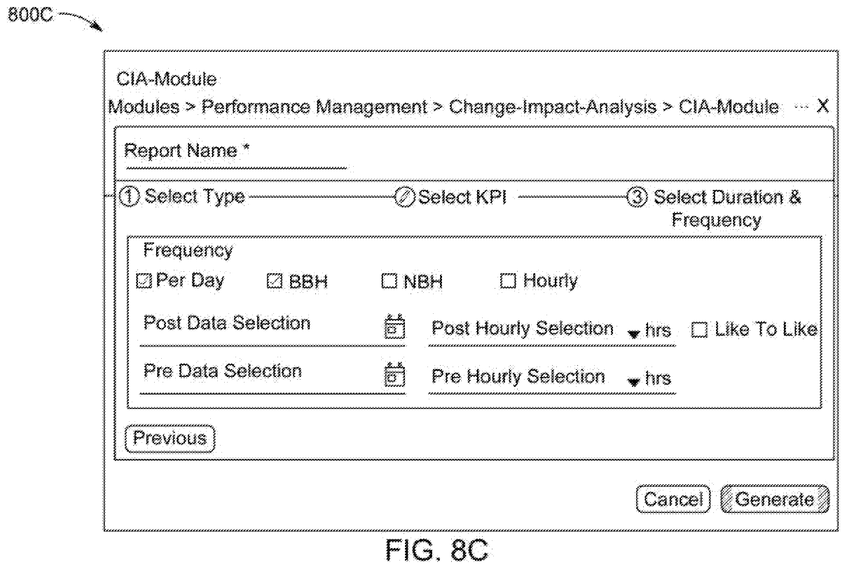

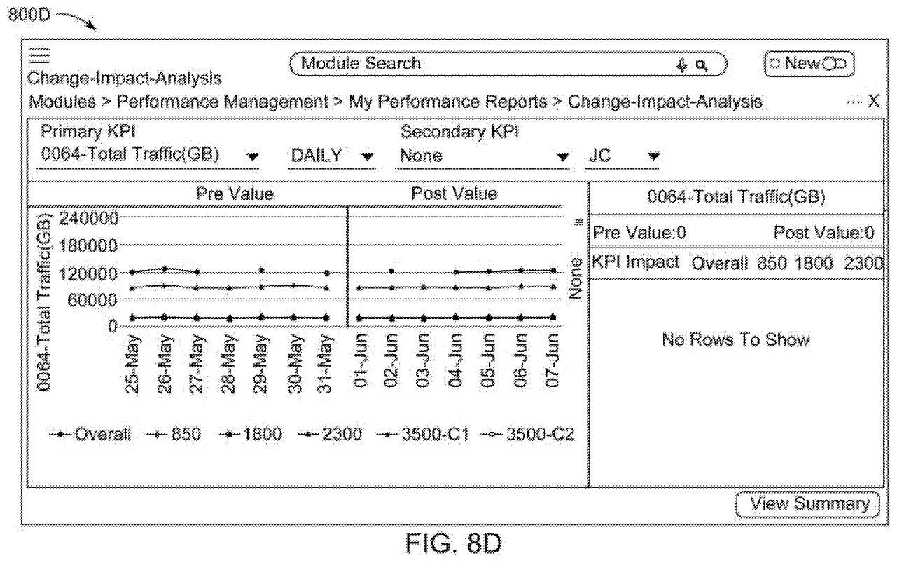

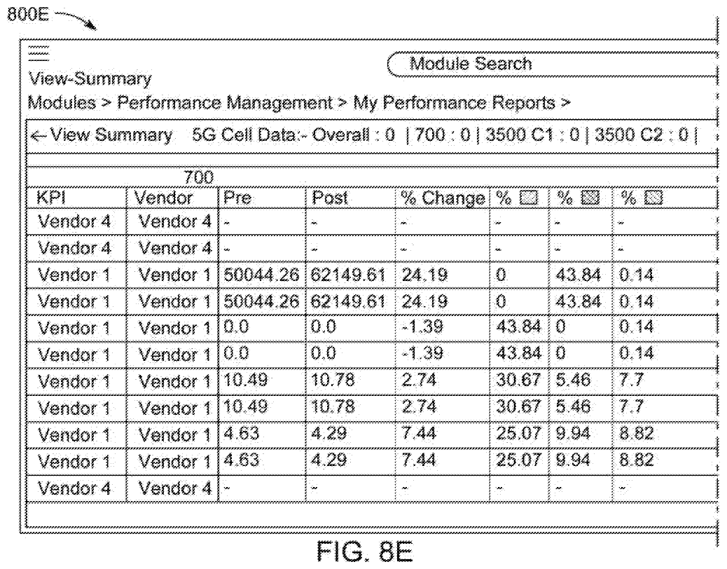

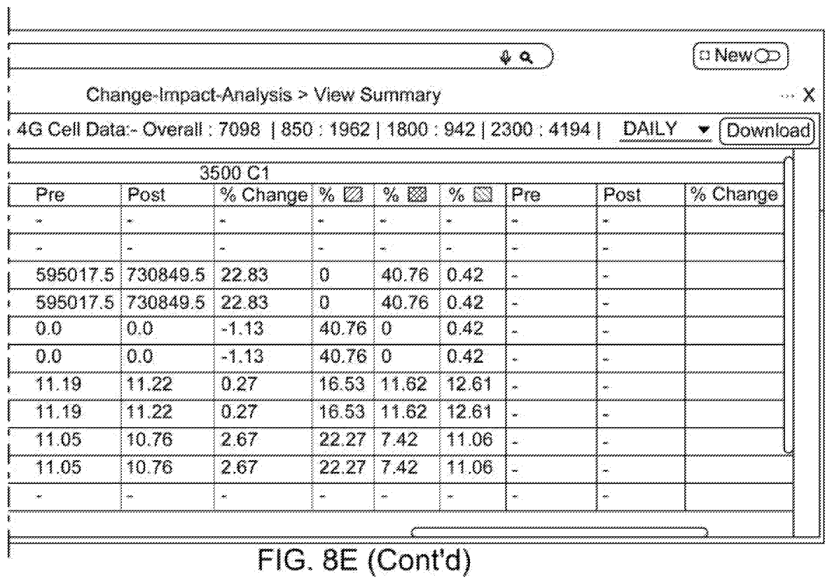

FIG. 8A illustrates a display (800A) of the interface(s) (206). A user (102) is configured to select a specific geographic region from a drop-down menu. This menu may likely display a list of countries, states, provinces, or other relevant geographic areas supported by the system. Alternatively, the user (102) may upload a custom cell list to define the geographic scope. This list could be a spreadsheet, CSV file, or any other format compatible with the system (200).

FIG. 8B illustrates a display (800B) of the interface(s) (206). A user (102) is configured to select any vendor and technologies using a dropdown menu. The selected vendors and technologies will display their corresponding KPIs in a dedicated KPI panel. The user (102) can then choose the desired KPIs from this panel and drag them to a right-side panel for analysis purposes. The interface(s) (206) allows the user (102) to easily customize their analysis by focusing on specific vendors, technologies, and KPIs relevant to their needs.

FIG. 8C illustrates a display (800C) of the interface(s) (206). A user (102) is configured to select the desired dates or days for analysis and the frequency of the analysis. This selection can be customized to include specific days of the week or particular date ranges.

FIG. 8D-8E illustrates a display (800D, 800E) of the interface(s) (206). An interface(s) (206) facilitates easy interpretation of analytical data. The interface(s) (206) allows the user (102) to navigate through various data visualizations, facilitating the discovery of insights and trends and making informed decisions based on the data analysis.

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). The components described above are meant only to exemplify various possibilities. In no way should the aforementioned exemplary computer system (700) limit the scope of the present disclosure.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method for automated change impact analysis that eliminates the need for manual scheduling, downloading, and data crunching and significantly reduces the time and effort required from engineers, especially when analyzing changes across large geographies.

The present disclosure provides a system and a method for automated change impact analysis that automates the data processing and computation tasks and reduces the risk of human errors.

The present disclosure provides a system and a method for automated change impact analysis that enables users to select multiple vendors, technologies, and KPIs for analysis.

The present disclosure provides a system and a method for automated change impact analysis that generates visualizations and summary reports based on the computed data.

The present disclosure provides a system and a method for automated change impact analysis that allows users to tailor the analysis to their specific needs, enhancing the relevance and applicability of the results.

1. A system for implementing automated change impact analysis in a network, the system comprising:
an interface configured to allow a user to select a plurality of parameters and key performance indicators (KPIs) from a selection menu for examination and specify a time period and frequency of analysis;
a data parameter engine configured to store and manage the plurality of parameters and the KPIs;
a processing engine coupled to the data parameter engine, the processing engine is configured to determine a true average impact data for each selected KPI; and
a database coupled to the processing engine for storing the true average impact data representing the change impact for each selected KPI for said time period.

2. The system as claimed in claim 1, wherein a Machine Learning (ML) module is configured to identify and remove anomalies in the determined true average impact data.

3. The system as claimed in claim 1, wherein the visual representation of the true average impact data is displayed on the interface.

4. The system as claimed in claim 1, wherein the selection menu includes at least a geographic region, a list of customized cells, one or more vendors, and/or one or more technologies.

5. (canceled)

6. The system as claimed in claim 1, wherein the user is configured to:
select at least one vendor and at least one technology from a predefined list or enter custom specifications for analysis; and
select KPIs for analysis based on downlink, uplink, latency, and/or total traffic

7. (canceled)

8. The system as claimed in claim 1, wherein said time period for analysis is selected by the user from a set of predefined options such as per day, Billing Busy Hour (BBH), and Network Busy Hour (NBH).

9. The system as claimed in claim 1, wherein the processing engine filters the list of KPIs based on a pre-defined criteria.

10. The system as claimed in claim 1, wherein the visual representation of change impact data is one or more of the following:
a time-series chart depicting the impact for each KPI over said time period;
a heatmap visually representing the change impact across selected geographic region(s) or customized cell(s); and
a table summarizing calculated change impact data for each KPI.

11. The system as claimed in claim 8, further comprising:
generating a detailed report summarizing the analysis, including:
the plurality of parameters;
calculated impact values for each KPI;
visual representation of the change impact data; and
a table summarizing the calculated impact values for each KPI.

12. A method for implementing automated change impact analysis in a network, the method comprising:
displaying, by an interface, a selection menu for enabling a selection of a plurality of parameters by a user;
presenting, based on the selection, a list of key performance indicators (KPIs) corresponding to the plurality of parameters within the interface;
receiving an input by the user to select one or more KPIs from said list of KPIs and a time period for processing;
determining, by a processing engine, a true average impact data corresponding to each of the one or more selected KPIs; and
displaying, by the interface, a visual representation of the true average impact data representing a change for each of the one or more selected KPIs for said time period.

13. The method as claimed in claim 12, wherein a Machine Learning (ML) module identifies and remove anomalies in the determined true average impact data.

14. The method as claimed in claim 12, wherein the selection menu includes at least a geographic region, a list of customized cells, one or more vendors, and/or one or more technologies.

15. (canceled)

16. The method as claimed in claim 12, further comprising:
selecting, by the user, at least one vendor and at least one technology from a predefined list or entering custom specifications for analysis; and
selecting, by the user, KPIs for analysis based on downlink, uplink, latency, and/or total traffic.

17. (canceled)

18. The method as claimed in claim 12, wherein said time period for analysis is selected by the user from a set of predefined options such as per day, Billing Busy Hour (BBH), and Network Busy Hour (NBH).

19. The method as claimed in claim 12, wherein the selection menu includes a drop-down menu.

20. The method as claimed in claim 12, further comprising filtering or sorting the list of KPIs based on a pre-defined criteria.

21. The method as claimed in claim 12, wherein the visual representation of change impact data is one or more of the following:
a time-series chart depicting the impact for each KPI over said time period;
a heatmap visually representing the change impact across selected geographic region(s) or customized cell(s); and
a table summarizing calculated change impact data for each KPI.

22. The method as claimed in claim 18, further comprising:
generating a detailed report summarizing the analysis, including:
the plurality of parameters;
calculated impact values for each KPI;
visual representation of the change impact data; and
a table summarizing the calculated impact values for each KPI.

23. A user equipment (UE) communicatively coupled with a network configured for implementing a method for automated change impact analysis in the network, the method comprises steps of:
displaying, by an interface, a selection menu for enabling a selection of a plurality of parameters by a user;
presenting, based on the selection, a list of key performance indicators (KPIs) corresponding to the plurality of parameters within the interface;
receiving an input by the user to select one or more KPIs from said list of KPIs and a time period for processing;
determining, by a processing engine, a true average impact data corresponding to each of the one or more selected KPIs; and
displaying, by the interface, a visual representation of the true average impact data representing a change for each of the one or more selected KPIs over/for said time period.

24. A computer program product comprising a non-transitory computer-readable medium comprising instructions that, when executed by one or more processors, cause the one or more processors to perform a method for automated change impact analysis in the network, the method comprises steps of:
displaying, by an interface, a selection menu for enabling a selection of a plurality of parameters by a user;
presenting, based on the selection, a list of key performance indicators (KPIs) corresponding to the plurality of parameters within the interface;
receiving an input by the user to select one or more KPIs from said list of KPIs and a time period for processing;
determining, by a processing engine, a true average impact data corresponding to each of the one or more selected KPIs; and
displaying, by the interface, a visual representation of the true average impact data representing a change for each of the one or more selected KPIs over/for said time period.
